(19) United States
(12) Patent Application Publication
(10) Pub. No.: US 2024/0093810 A1
(43) Pub. Date: Mar. 21, 2024

(54) CORRUGATED TUBING WITH EXTERNAL REINFORCEMENT

(71) Applicant: INDUSTRIE ILPEA S.P.A., Malgesso (IT)

(72) Inventors: Claudio Damiano CATALDO, Cugliate Fabiasco (IT); Paolo CITTADINI, Luvinate (IT)

(73) Assignee: INDUSTRIE ILPEA S.P.A., Malgesso (IT)

(21) Appl. No.: 18/260,501

(22) PCT Filed: Jan. 14, 2022
(86) PCT No.: PCT/IB2022/050286

§ 371 Date: Jul. 6, 2023

(30) Foreign Application Priority Data
Jan. 15, 2021 (IT) 102021000000662

(51) Int. Cl. F16L 11/112

(52) U.S. Cl. CPC F16L 11/112

(57) ABSTRACT

A flexible tubing for hydraulic and/or hydrodynamic use, said tubing comprising a main flexible tubular body made of thermoplastic material which extends about a longitudinal extension axis, the sections of said main tubular body being substantially circular on planes perpendicular to said longitudinal extension axis, said main tubular body being of a corrugated type and thus conformed to define a first plurality of ridges or shoulders arranged in succession and a second plurality of dips or valleys arranged in succession to connect each of two consecutive ridges or shoulders.

### CROSS-REFERENCE TO RELATED PATENT APPLICATIONS

This application is a U.S. National Stage Application under 35 U.S.C. § 371 of International Patent Application No. PCT/162022/050286 filed Jan. 14, 2022, which claims the benefit of priority of Italian Patent Application No. 102021000000662 filed Jan. 15, 2021, both of which are incorporated by reference in their entireties. The International Application was published on Jul. 21, 2022, as International Publication No. WO 2022/153227 A1.

### TECHNICAL FIELD OF THE INVENTION

The present invention belongs to the field of transport of liquids and/or fluids. In particular, the present invention belongs to the field of tubing for transporting liquids or in general fluids. More in particular, the present invention relates to a tubing of the aforesaid type used to easily connect components of hydraulic and/or hydrodynamic systems, to allow the transport of said fluids, possibly under pressure, between said components.

In detail, the present invention relates to a tubing or pipe of the corrugated type, i.e., shaped to define a plurality of shoulders and dips arranged in an alternating manner, i.e., wherein between each pair of consecutive shoulders, there is a dip connecting said consecutive shoulders.

Even more in detail, the present invention relates to a corrugated type tubing comprising an external reinforcing spiral.

### BACKGROUND ART

The use of flexible tubings or pipes for the easy and reliable connection of components of hydraulic and/or hydrodynamic systems is well known and widespread in the prior art, to allow the transport of fluids, in particular but not exclusively under pressure, between said components.

In particular, the tubings according to the prior art are often made of polymeric material, thermoplastic materials, and vulcanized rubbers, according to the applications for which they are intended, and so that the tubings comply with various requirements including no leakage points (the tubing must be tight), resistance to the pressures applied by the transported fluid, resistance to the temperatures of the transported fluid and more generally of the working environment, resistance to the collapse of the tubing when bent to follow and define tight bending radii. Furthermore, for applications in the heating and plumbing sector, for example, the requirements for contact with drinking water often have to be added to the requirements mentioned above.

The need to meet the aforesaid requirements led to the development of several solutions which can be summarized as:
Smooth tubings made of vulcanized rubber with external textile or metal braid reinforcement, as in U.S. Pat. No. 3,994,673 A;
smooth tubings made of soft thermoplastic materials with external reinforcement in textile or metallic braid or with reinforcement obtained by a double spiral of textile fibers;
corrugated tubings with textile or metal braid reinforcement, as in EP 0748972 A1.

The first group comprises tubings made of vulcanized rubber monolayer or multilayer, typically in EPDM (Ethylene-Propylene Diene Monomer), used in various fields, from the hydraulic sector (connections under the sink) to the automotive sector or the hydrodynamic sector.

The second group comprises, for example, soft PVC water inlet tubings for household appliances, such as washing machines and dishwashers, or even conventional “garden hoses”.

The third group comprises the tubings of the heating and plumbing sector for applications in which tight bending radii without tubing collapse are required. The corrugated tubing can also be made of thermoplastic materials which meet even more stringent requirements in terms of suitability for contact with drinking water, thus overcoming the intrinsic limits of vulcanized rubber tubings.

In particular, the need to create tubings capable of withstanding the operating pressures and/or temperatures has led to the idea of applying a mechanical reinforcement consisting of a braid or a double spiral externally to the tubing and sometimes even in an “integrated” manner in the structure of the tubing.

The braiding technique (application/formation of the braid) consists in braiding on the tubing a series of metallic filaments (stainless steel, galvanized, etc) or textile filaments (polyester, nylon, Kevlar, etc) which compose a real fabric enclosed on the tubing itself, allowing the achievement of very high bursting pressures. This production method is the best performing from a mechanical point of view because the braid filaments are kept in position on the tubing by the structure of the braid itself, which is a real fabric made up of various threads. Tubings with this type of reinforcement can reach burst pressures comprised between 50 and 150 bar as a function of (depending on) the nature of the reinforcing fiber (metallic rather than textile) and the diameter of the tubing.

The double spiral technique, on the other hand, consists of depositing two spirals of n threads on the tubing at the same time (an example of configuration is with 16 threads) in an opposite direction—clockwise and counterclockwise—which together create a lattice which contributes to increasing the bursting resistance of the tubing. Since the double helix is not a fabric, i.e. a structure in which each thread is held in place by the other threads, these filaments must be “embedded” in the thermoplastic matrix which makes up the tubing, so that the filaments do not move as a result of bending of the tubing or as a result of internal pressures; indeed, if this were not the case, a weak point would be created in the tubing in which the reinforcing element is not present, and the tubing would fail prematurely. It is common to find on these tubings also filaments arranged longitudinally whose purpose is to counteract the elongation of the tubing when subjected to internal pressure. The reinforcing fibers used are mainly textile, typically polyester but sometimes also nylon, Kevlar, etc.

The spiraling process consists of a first step during which the filaments are laid on the surface of the tubing to be reinforced, and a successive step of the cohesive coating of the tubing with a material compatible with the material of which the tubing is made, thus maintaining the reinforcement fibers in a fixed position.

Tubings with this type of reinforcement can withstand pressures of up to 20-50 bar as a function of the diameter of the tubing and the type of fiber used.

The main advantage offered by spiraling compared to braiding lies in the high production speed, which can reach up to 20-25 m/min.

The smooth, corrugated tubing of the known type briefly described above, while appreciable for the aforesaid advantages, nevertheless has disadvantages and/or drawbacks which the owner of the present patent application intends to overcome with the tubing according to the present invention.

A first drawback of the smooth tubings reinforced by means of a braid is given by the high cost generated by the number of filaments deposited on the tubing and especially by the manufacturing speed of the braid which is 1-1.5 m/min as a function of the diameter of the tubing to be coated.

Concerning corrugated tubings, the main drawback is the fact that they are not suitable to be subjected to the spiral process.

Indeed, the regular arrangement of the spiral fibers is optimal only when it is deposited on a smooth tubing on which to lay the filaments because as the thread is not self-supporting as would be in the case of braiding, maintaining the position of the reinforcing fiber on the tubing is problematic; in particular, even the pressure applied by the molten material during the step of over-extruding (external tubing coating) would be able to displace the fibers, where a poor positioning of the fibers results in a loss of mechanical strength.

It is thus the main object of the present invention to overcome or at least minimize the drawbacks outlined above and affecting the prior art.

In particular, it is a first object of the present invention to make available a corrugated type tubing reinforced with an external spiral.

It is a second, not secondary object of the present invention to make available a tubing of the aforesaid type which offers both the typical advantages of corrugated tubing and those provided by the external spiral.

A non-secondary purpose of the present invention is to provide a tubing which:
can be curved or bent to define even very tight radii of curvature without the risk of collapse;
guarantees adequate resistance to even very high internal pressures, thus reducing or avoiding the risk of bursting or leaks;
is suitable to meet the most stringent requirements for suitability for contact with drinking water;
can be manufactured at low costs and in any case competitive with the tubing according to the prior art.

### DESCRIPTION OF THE PRESENT INVENTION

The present invention is based on a novel concept of applying a reinforcing spiral to a corrugated core.

As explained below, the general concept described above requires the corrugated core to be made adapted to receive the spiraling by prior application of a smooth coating, in particular one which simulates a smooth tubing.

In view of the above, as well as of the problems and/or drawbacks encountered in the flexible tubing according to the prior art, the present invention relates to a flexible tubing according to claim 1, wherein further embodiments of the tubing according to the present invention are defined by the dependent claims.

According to a first described embodiment, a flexible tubing, in particular for hydraulic and/or hydrodynamic use, comprises a main flexible tubular body made of thermoplastic material which extends about a longitudinal extension axis, the sections of said main tubular body being substantially circular on planes perpendicular to said longitudinal extension axis, said main tubular body being of a corrugated type and thus conformed to define a first plurality of ridges or shoulders arranged in succession and a second plurality of dips or valleys arranged in succession to connect each of two consecutive ridges or shoulders; wherein said main tubular body is housed within a first coating made of thermoplastic elastomer, and wherein said tubing comprises a spiraling constituted by a plurality of filaments each spirally wound on said first coating made of thermoplastic elastomer.

According to the described embodiment, the diameter of each of the coils defined by said filaments is either equal to or greater than the maximum outer diameter of said main tubular body, wherein said filaments are thus arranged outside said valleys of said main tubular body.

According to a described embodiment, said tubing comprises a second outer thermoplastic elastomer coating, wherein said filaments of said spiraling are embedded in said second outer thermoplastic elastomer coating.

According to a described embodiment, said spiraling comprises a first plurality of filaments each spirally wound on said first coating according to a first winding direction, and a second plurality of filaments each spirally wound on said first coating according to a second winding direction opposite to said first winding direction, wherein said filaments of said first plurality and second plurality are mutually arranged to define a lattice.

According to a described embodiment, said filaments of said spiraling are made of a textile material such as polyester, nylon, Kevlar, or similar material.

According to a described embodiment, said second outer coating is internally substantially cylindrical and of smooth tubular type, wherein the minimum inner diameter of said second outer coating is either equal to or greater than the maximum outer diameter of said main tubular body and said first coating, wherein said second outer coating does not follow the corrugation of said main tubular body and/or said first coating.

According to a described embodiment, said second outer coating is made by over-extrusion on said spiraling wound on said first coating in which said main tubular body is housed.

According to the described embodiment, said first external outer coating is substantially cylindrical inside and of smooth tubular type, wherein the minimum inner diameter of said first coating is either equal to or greater than the maximum outer diameter of said main tubular body, wherein said first outer coating does not follow the corrugation of said main tubular body.

According to a described embodiment, said first outer coating is made by over-extrusion on said main tubular body.

According to a described embodiment, said main tubular body is of a two-layer type, wherein said main tubular body comprises a main inner layer and an outer layer, and thus wherein said first coating comprises the outer layer of said main tubular body.

According to a described embodiment, said tubular body is made by simultaneous co-extrusion of said main inner layer and outer layer.

According to a described embodiment, said main tubular body is of the square wave and narrow valley type, wherein each of said shoulders is bounded externally by a substantially cylindrical surface.

According to a described embodiment, the longitudinal extent of said substantially cylindrical surface of each of said shoulders is either equal to or greater than twice the longitudinal pitch of said coils of said spiraling.

According to a described embodiment, the longitudinal extent of said substantially cylindrical surface of each of said shoulders is either equal to or greater than twice the maximum longitudinal distance between two consecutive shoulders.

According to any one of the described embodiments, the thickness of said main tubular body is between 0.4 mm and 0.6 mm and/or an inner diameter is comprised between 6 mm and 24 mm.

According to a described embodiment, said first coating has an average thickness comprised between 0.2 mm and 0.3 mm.

According to a described embodiment, said second outer coating has a thickness comprised between 0.5 mm and 1 mm.

### BRIEF DESCRIPTION OF THE DRAWINGS

Hereafter, the present invention will be further clarified by means of the following detailed description of the possible embodiments depicted in the drawings, in which corresponding or equivalent features and/or component parts of the present invention are identified by the same reference numerals. It must be noted that the present invention is not limited to the embodiments described hereafter and depicted on the accompanying drawings; on the contrary, all the variants and/or changes to the embodiments described below and shown on the accompanying drawings which will appear obvious and immediate to a person skilled in the art are comprised in the scope of the present invention.

In the drawings:

FIGS. 1 and 2 show a perspective view in partial section and respectively a longitudinal section view of a tubing according to an embodiment;

FIG. 3 is 4 show longitudinal section views of a tubing and a detail thereof according to an embodiment.

### DETAILED DESCRIPTION OF THE PRESENT INVENTION

The present invention is particularly applied in the field of dispensing and transmission systems of water or liquid in general, in particular for mutually connecting components, e.g. such as the components of household appliances, this being the reason for which the present invention is described hereafter with particular reference to its applications in the field of components for household appliances.

However, it is worth specifying that the possible applications of the present invention are not limited to those described hereafter. On the contrary, the present invention is conveniently applied in all cases in which it is necessary to hydraulically connect components of any type, e.g. hydrodynamic systems.

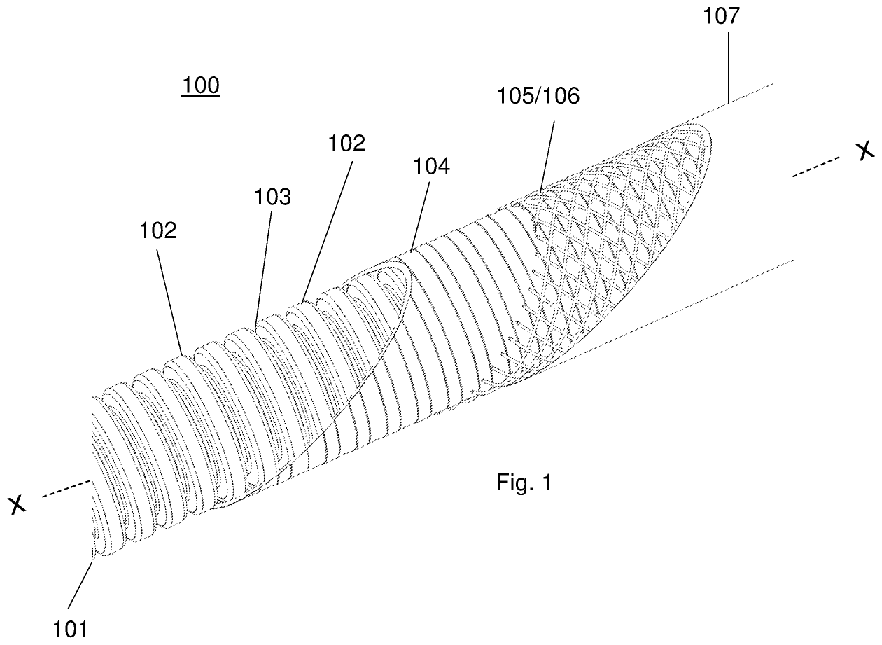

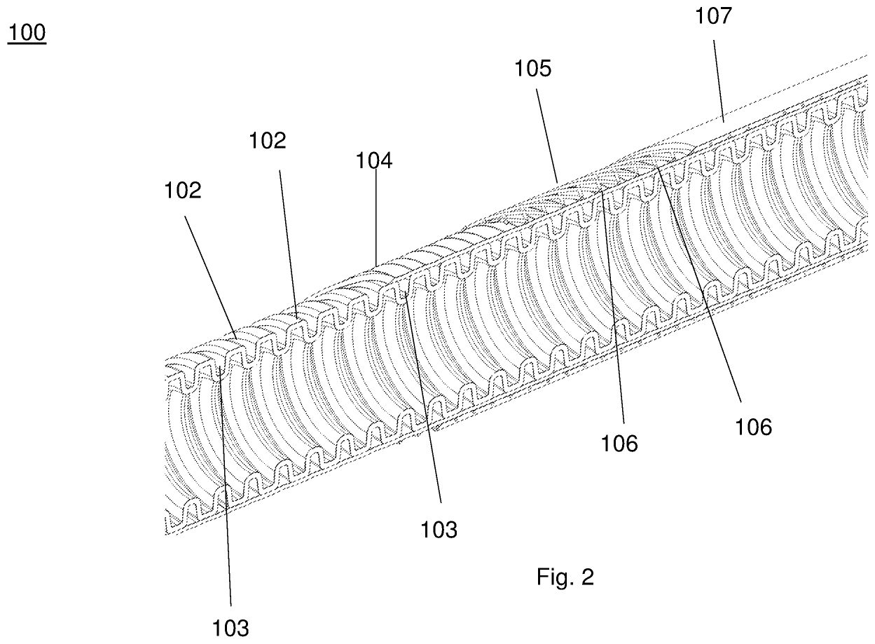

According to the embodiment as depicted in FIGS. 1 and 2, the tubing shown therein, identified by reference numeral 100 and hereafter referred to simply as tubing or tube for the sake of briefness, comprises, from the inside out, a corrugated tubing (a main tubular body of the corrugated type) 101, a smooth coating 104 which surrounds and encloses within itself the main tubular body 101, a plurality of filaments 106 each wound spirally over the coating 104 to define a spiral 105, and finally an outer layer or coating 107 which surrounds and encloses within itself the spiral 105 and thereby also the inner coating 104 and the main tubular body of corrugated type 101.

The main body 101 is developed, as shown, along an extension direction X-X and, being of a corrugated type, comprises, as usual, a plurality of shoulders or protrusions (also called ridges) 102 arranged in succession along the direction X-X, and a plurality of valleys or dips 103 also arranged in succession along the direction X-X, wherein the shoulders 102 and the valleys 103 are mutually alternated along the direction X-X, and wherein, therefore, each valley 103 connects two consecutive shoulders 102 (and likewise each shoulder 102 connects two consecutive valleys 103). For the purposes of the present invention, in particular according to the embodiment shown in FIGS. 1 and 2, the shoulders 102 and the valleys 103 may have any conformation (e.g., one conformation among those according to the prior art), wherein a detailed description thereof is omitted for the sake of brevity.

The materials may be those as a function of the applications of the tubing 100, wherein by way of non-limiting example, the main tubular body 101 may be made of thermoplastic material (e.g., with an average wall thickness of about 0.5 mm, and an inner diameter between 6 to 24 mm), the inner liner 104 may be made of thermoplastic elastomer compatible with the material of the main body 101 (e.g., with an average thickness of 0.2-0.3 mm), the filaments 106 may be either metallic or textile type (e.g., polyester but also nylon, Kevlar, and similar materials).

By way of non-limiting example, the tubing 100 shown in FIGS. 1 and 2 may be constructed by the following procedure.

Forming on the main body 101 of the smooth inner liner 104 by means of the over-extrusion technique on the corrugated tubing 101;
the application by the technique of spiraling the reinforcing fibers or filaments 106, e.g., sixteen clockwise filaments 106, sixteen counterclockwise filaments 106, and possibly four/six longitudinal filaments 106, onto the coating 104;
formation of the outer coating or layer 107 by means of the over-extrusion technique to encompass the spiral 105 which will then be embedded in the outer coating 107.

According to alternative embodiments, the outer coating 107 can also be omitted. Thus, it is apparent that the purpose of the inner coating 104 is to make the main body 101 resemble a tubular body externally not corrugated but substantially smooth. Indeed, the inner coating 104, made in the form of a tubular sheath, allows the formation of the spiral 105 as in the case of a smooth tubing and thus to avoid the risk of the filaments 106 moving accidentally (already during the step of spiraling and/or during the over-extrusion of the outer coating 107).

As anticipated, the coating 104 may be constructed as a tubular sheath and thus either to leave the valleys 103 of the main body 101 substantially empty or to substantially fill said valleys 103.

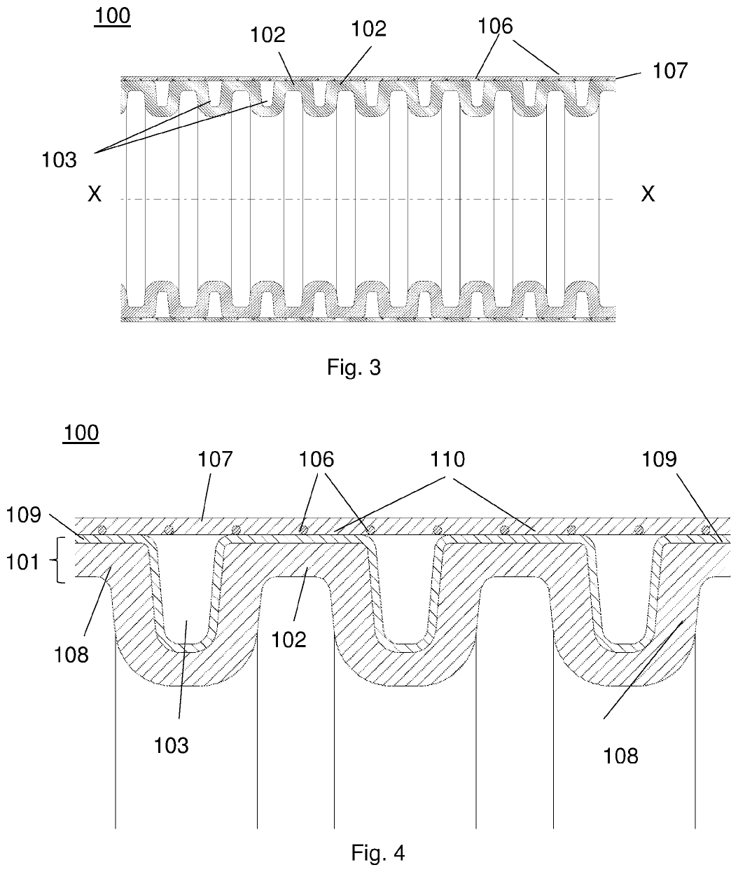

The embodiment depicted in FIGS. 3 and 4 differs from that shown in FIGS. 1 and 2 in that the main tubular body 101 is of the double layer type and thus comprises a main inner layer 108 (e.g., PP) and an outer layer 109 (e.g., TPE-S) made, for example (but not necessarily), by the simultaneous co-extrusion technique. According to this embodiment, the outer layer 109 replaces the inner coating 104 of the embodiment in FIGS. 1 and 2 by performing substantially the same functions.

Therefore, the outer layer 109 has the main function of allowing the formation of the spiraling by preventing the accidental displacement of the filaments 106, in particular by preventing the spirals from being deposited predominantly in the valleys 103 by virtue of at least in part but not solely to the high friction coefficient of the thermoplastic rubber surface of the layer 109.

Furthermore, for this purpose (and as shown), the corrugated conformation may be chosen so that the shoulders 102 define a preferred bearing surface for the filaments 106. In particular, the main tubular body 101 may be of the “square wave and narrow valley” type, wherein that is, each shoulder 102 is bounded externally by a substantially cylindrical surface 110 which serves as a support for the filaments 106. Eventually, the longitudinal extent (along the X-X axis) of the surfaces 110 may be chosen as a function of the pitch of the coils defined by the filaments 106, and that is, as a function of the longitudinal distance (along the X-X axis) between two successive coils, e.g. so that the longitudinal extent of each surface 110 is greater than or at least equal to twice the pitch of the coils of the spiral 105.

In this case, the method for making the tubing 100 may comprise:
applying reinforcing fibers or filaments 106 directly to the double-layer main body 101, and then to the outer layer 109, e.g., such as by spiraling sixteen filaments 106 clockwise, sixteen filaments 106 counterclockwise, and possibly four to six longitudinal filaments 106;
the formation of the coating or outer layer 107 by means of the over-extrusion technique.

It has thus demonstrated by means of the detailed description given above of the embodiments shown in the drawings that the present invention makes it possible to achieve the desired objects and to overcome or at least limit the drawbacks affecting the prior art.

In particular, the present invention makes available a tubing 100 which:
has an essentially “monolithic” thermoplastic structure by virtue of the chemical compatibility between the various components or layers which guarantee good weldability;
has properly spirally positioned reinforcing fibers 106 by virtue of to the presence of a substrate or coating 104 equivalent to a smooth tubing;
wherein the fibers 106 maintain their position on the tubing 100 (on the main body 101) as a result of welding between the inner coating 104 and the outer coating 107 both made of thermoplastic elastomer;
has unique advantages such as resistance to high bursting pressures by virtue of the reinforcement fibers 106 (20-50 bar), resistance to high temperatures by virtue of the reinforcement fibers 106, and an appropriate selection of the thermoplastic material of the corrugated tubing (e.g. 90° C. for PP tubings and polyester fibers), ability to reach tight bending radii without collapsing by virtue of the main tubular body 101 of the corrugated type, up to 1.5-2 times the diameter of the tubing, suitability for contact with potable water also according to the most stringent regulations in this area (W270, NSF, etc).

Although the present invention is explained above by means of a detailed description of the embodiments thereof shown in the drawings the present invention is obviously not limited to the embodiments described above and shown on the drawings; on the contrary, all the variants and/or changes to the embodiments described and shown on the accompanying drawings are comprised in the object of the present invention and will be apparent and immediate to a person skilled in the art. For example, the corrugated main body 101 may be made of polyolefin resin, and the coating layers 104 and 107 of TPE-V or TPE-S.

The scope of protection of the present invention is thus defined by the claims.

1. A flexible tubing for hydraulic and/or hydrodynamic use, said tubing comprising a main flexible tubular body made of thermoplastic material which extends along an axis of longitudinal extension, the sections of said main tubular body being substantially circular on planes perpendicular to said longitudinal extension axis, said main tubular body being of a corrugated type and thus conformed to define a first plurality of ridges or shoulders arranged in succession and a second plurality of dips or valleys arranged in succession to connect each of two consecutive ridges or shoulders, wherein said main tubular body is housed within a first coating made of thermoplastic elastomer, wherein said tubing comprises a spiraling constituted by a plurality of non-braided filaments, each spirally wound on said first coating made of thermoplastic elastomer, wherein said tubing comprises a second outer coating made of thermoplastic elastomer, wherein said filaments of said spiraling are embedded in said second outer coating made of thermoplastic elastomer.

2. The tubing according to claim 1, wherein the diameter of each of the coils defined by said filaments is either equal to or greater than the maximum outer diameter of said main tubular body, wherein said filaments are arranged outside said valleys of said main tubular body.

3. The tubing according to claim 1, wherein the outer surface of said first coating is smooth or substantially smooth.

4. The tubing according to claim 1, wherein said spiraling comprises a first plurality of filaments each spirally wound on said first coating according to a first winding direction, and a second plurality of filaments each spirally wound on said first coating according to a second winding direction opposite to said first winding direction, wherein said filaments of said first plurality and second plurality are mutually arranged to define a lattice.

5. The tubing according to claim 1, wherein said filaments of said spiraling are made of textile material, such as polyester, nylon, Kevlar or similar material.

6. The tubing according to claim 1, wherein said second outer coating is internally substantially cylindrical and of smooth tubular type, wherein the minimum inner diameter of said second outer coating is either equal to or greater than the maximum outer diameter of said main tubular body and said first coating, wherein said second outer coating does not follow the corrugation of said main tubular body and/or said first coating.

7. The tubing according to claim 6, wherein said second outer coating is made by over-extrusion on said spiraling wound on said first coating in which said main tubular body is housed.

8. The tubing according to claim 1, wherein said first outer coating is internally substantially cylindrical and of smooth tubular type, wherein the minimum inner diameter of said first coating is either equal to or greater than the maximum outer diameter of said main tubular body, wherein said first outer coating does not follow the corrugation of said main tubular body.

9. The tubing according to claim 8, wherein said first coating is made by over-extrusion on said main tubular body.

10. The tubing according to claim 1, wherein said main tubular body is of a double-layer type, wherein said main tubular body comprises a main inner layer and an outer layer, wherein said first coating consists of said outer layer of said main tubular body, wherein said main tubular body is of the square wave and narrow valley type, wherein each of said shoulders is externally delimited by a substantially cylindrical surface.

11. The tubing according to claim 10, wherein said main tubular body is made by simultaneous coextrusion of said main inner layer and outer layer.

12. The tubing according to claim 10, wherein the longitudinal extent of said substantially cylindrical surface of each of said shoulders is either equal to or greater than twice the longitudinal pitch of said coils of said spiraling.

13. The tubing according to claim 10, wherein the longitudinal extent of said substantially cylindrical surface WA) of each of said shoulders is either equal to or greater than twice the maximum longitudinal distance between two consecutive shoulders.

14. The tubing according to claim 1, wherein said first coating of the main tubular body.

15. The tubing according to claim 1, wherein the thickness of said main tubular body is between 0.4 mm and 0.6 mm and/or an inner diameter of said main tubular body is between 6 mm and 24 mm.

16. The tubing according to claim 1, wherein said first coating has an average thickness comprised between 0.2 mm and 0.3 mm.

17. The tubing according to claim 1, wherein the thickness of said second outer coating is comprised between 0.5 mm and 1 mm.

18. The tubing according to claim 1, wherein the main tubular body, the first coating and the second coating are made of chemically compatible materials, so that the first coating and the second coating are welded together and form a cohesive coating of the main tubular body.

19. The tubing according to claim 1, wherein the main tubular body is made of polyolefin resin, wherein the first coating and the second coating are made of TPE-V or TPE-S.
